(19) United States
(12) Patent Application Publication
(10) Pub. No.: US 2026/0328209 A1
(43) Pub. Date: Oct. 22, 2026

(54) SCROLL COMPRESSOR

(71) Applicant: OET GMBH, Lustenau (AT)

(72) Inventors: Christian BUSCH, Feldkirch (AT); Markus ÖTTL, Lustenau (AT)

(21) Appl. No.: 19/099,448

(22) PCT Filed: Jun. 23, 2023
(86) PCT No.: PCT/EP2023/067170

§ 371 Date: Jan. 28, 2025

(30) Foreign Application Priority Data
Aug. 2, 2022 (DE) 102022119354.3

(51) Int. Cl. F04C 18/02; B60H 1/00; B60H 1/32; F04C 29/00

(52) U.S. Cl. CPC F04C 18/0207; B60H 1/3223; F04C 29/0057; F04C 29/0085; B60H 1/00385; F04C 2240/30; F04C 2240/40; F04C 2240/50

(57) ABSTRACT

The invention relates to a scroll compressor comprising a housing with a housing cover and an intermediate housing wall, an electric drive unit, which is connected to an eccentric bearing by a drive shaft having an axle (A), a movable displacement spiral rotatable about an eccentric axis (EA) and connected to the eccentric bearing, and a stationary counter-spiral in engagement with the displacement spiral; wherein—the intermediate housing wall and the displacement spiral are arranged on a suction side (SA) and the housing cover and the counter-spiral are arranged on a high-pressure side (HD), —a plurality of cylindrical recesses are formed on the side of the displacement spiral facing the suction side (SA), and—pins are arranged on the side of the intermediate housing wall facing the high-pressure side (HD), in such a way that they project into the cylindrical recesses and co-operate therewith, so that a guide for the movable displacement spiral is formed, and, preferably, —a ring element surrounding the pin is arranged in each of the cylindrical recesses, wherein the pins span an imaginary polygon (P), and wherein at least one internal angle (W1, W2, W3, W4, W5, W6) of the polygon (P) differs from another of the internal angles (W1, W2, W3, W4, W5, W6) and/or from 120°.

### CROSS-REFERENCE TO RELATED APPLICATIONS

This application is a National Stage Application of International Application. No. PCT/EP2023/067170, filed on Jun. 23, 2023, which claims benefit of priority to German Patent Application No. 10 2022 119 354.3, filed on Aug. 2, 2022 which applications are incorporated herein by reference in their entirety. To the extent appropriate, a claim of priority is made to each of the above disclosed applications.

### FIELD

The invention relates to a scroll compressor. Furthermore, the invention relates to a vehicle air conditioning system and a motor vehicle with such a scroll compressor.

### BACKGROUND

A scroll compressor of the type mentioned above is known, for example, from DE 10 2019 108 417 A1. It describes a scroll compressor that is particularly suitable for use in electric vehicles. The problem with electric vehicles is that the omission of an internal combustion engine, which is used in conventional vehicles, means that noise from ancillary units comes to the fore. These noises are usually triggered by structure-borne sound transmissions from the ancillary units. This is particularly true for compressors of vehicle air conditioning systems, which are audible in conventional electric vehicles and can also be felt due to their vibrations. There is therefore a need to reduce the vibrations and structure-borne sound transmissions generated by the ancillary units, particularly scroll compressors. The above-mentioned DE 10 2019 108 417 A1 provides a solution for this in which rings of a so-called pin-ring system, which guides the orbiting displacement spiral, are mounted in a dampening manner by means of a lubricant. Although the dampening mount already leads to a significant reduction in vibrations and noise emissions, there is still need for improvement.

In the known pin-ring system, the pins that engage in the rings are arranged in such a way that they form a regular polygon. The polygon has internal angles that are identical and can be calculated by using the following formula:

$$a = \frac{( n - 1 ) \cdot 180 °}{n} \qquad ( Equation 1 )$$

Against this background, the object of the present invention is to specify a scroll compressor which offers further improvements in terms of low vibration and a low noise operation. Furthermore, it is the object of the invention to specify a vehicle air conditioning system and a motor vehicle with such a scroll compressor.

Thus, the invention is based on the idea of specifying a scroll compressor comprising a housing with a housing cover and an intermediate housing wall, furthermore comprising an electric drive unit connected to an eccentric bearing by a drive shaft having an axis, as well as a movable displacement spiral connected to the eccentric bearing in such a manner that it can be rotated around an eccentric axis, and an stationary counter-spiral in engagement with the displacement spiral. In the the scroll compressor, the intermediate housing wall and the displacement spiral are arranged on a suction side and the housing cover and the counter-spiral are arranged on a high-pressure side. On the side of the displacement spiral facing the suction side, a plurality of cylindrical recesses are formed. On the side of the intermediate housing wall facing the high-pressure side, pins are arranged in such a way that they project into the cylindrical recesses and co-operate therewith so that a guide for the movable displacement spiral is formed. Preferably, a ring element surrounding the pin is arranged in the cylindrical recesses.

According to the invention, the pins span an imaginary polygon, wherein at least one interior angle of the polygon differs from another of the interior angles and/or differs from 120°, In particular, in the case of the variant according to the invention, in which one interior angle differs from at least one of the other interior angles, the above equation 1 is not valid.

Essentially, in the case of the invention, the pins are asymmetrically distributed. It has been shown that such an asymmetrical distribution of the pins leads to lower resonances or vibration increases. This noticeably reduces the noise emissions of a scroll compressor. The scroll compressor is therefore particularly suitable as a smooth-running unit for a vehicle air conditioning system for electric vehicles.

The transformation from combustion engines to electric drives in today's motor vehicles also means that installation space is saved in the vehicle. Electric motors simply require less installation space than combustion engines so that ancillary units can be designed larger. The installation space now available also allows the use of larger scroll compressors so that the number of pins and associated ring elements can be increased. In particular, not only three, four or five pins can be provided. Rather, it is conceivable that seven, eight, nine or more pins are provided. An increase in the number of pins also leads directly to increased smoothness, which results in a further reduction of noise emissions.

In a preferred embodiment of the invention, the recesses and/or pins, in particular the ring elements, are provided with and/or touch a non-metallic material, preferably plastic. In this way, vibrations are also reduced, particularly if the non-metallic material has dampening properties. Suitable plastics can have such a dampening effect.

The scroll compressor may also require a pair of adjacent pins to span a pin pair angle around the axis of the drive shaft, wherein the pin pair angle of one pair differs from the pin pair angle of at least one other pair. In particular, the pin pair angle of one pair may be at least 1% larger and/or smaller than the pin pair angle of at least one other pair, in particular by at least 2%, in particular by at least 5%, in particular by at least 10%, in particular by at least 20%, in particular by at least 40%, in particular by at least 50%.

Furthermore, it may be provided that the pins are arranged on at least two pitch circles of different sizes around the axis of the drive shaft. In particular a second pitch circle may be at least 1% larger and/or smaller than a first pitch circle, in particular by at least 2%, in particular by at least 5%, in particular by at least 10%, in particular by at least 20%, in particular by at least 40%, in particular by at least 50%. The different pin pair angles and/or the different pitch circles result in an asymmetrical arrangement of the pins, which has proven to be particularly vibration-reducing in practice. This special arrangement of pins and associated recesses makes a significant contribution to reducing noise emissions.

In another preferred embodiment, the scroll compressor has a stator surrounding the drive shaft, in particular comprising twelve stator grooves, a rotor with, in particular, ten, rotor-pole pairs and preferably seven pins. Such a configuration has proven to be particularly effective in reducing vibration and noise emissions.

In this context, it is particularly favourable if the number of stator grooves or rotor-pole pairs can only be divided by the number of pins with a remainder.

Alternatively, it can be provided that the stator comprises 12 stator grooves and the rotor comprises eight rotor-pole pairs.

A secondary aspect of the invention relates to a vehicle air conditioning system with a scroll compressor described above. Another secondary aspect relates to a motor vehicle with such a vehicle air conditioning system. The motor vehicle may preferably have at least a partially electric vehicle drive.

### DRAWINGS

The invention is explained in more detail below by means of exemplary embodiments with reference to the appended schematic drawings. The figures show:

FIG. 1 a longitudinal section view by means of a scroll compressor according to the invention in accordance with a preferred exemplary embodiment;

FIG. 2 a cross-sectional view through a movable displacement spiral of a scroll compressor according to the invention in accordance with FIG. 1, wherein the pins are arranged on pitch circles of different diameters;

FIG. 3 a cross-sectional view through a displacement spiral of a scroll compressor according to the invention in accordance with a further exemplary embodiment, wherein the pins span a polygon which has different interior angles;

FIG. 4 a cross-sectional view through a displacement spiral of a scroll compressor according to the invention with four pins spanning a polygon with different interior angles;

FIG. 5 a cross-sectional view through a displacement spiral of a scroll compressor according to the invention in accordance with another preferred exemplary embodiment, wherein four pins are provided, one of which is arranged on a different pitch circle diameter; and

FIG. 6 a cross-sectional view through a displacement spiral of a scroll compressor according to the invention in accordance with another preferred exemplary embodiment, wherein four pins are provided, which span in polygon with interior angles, each of which is different from 120°.

### DETAILED DESCRIPTION

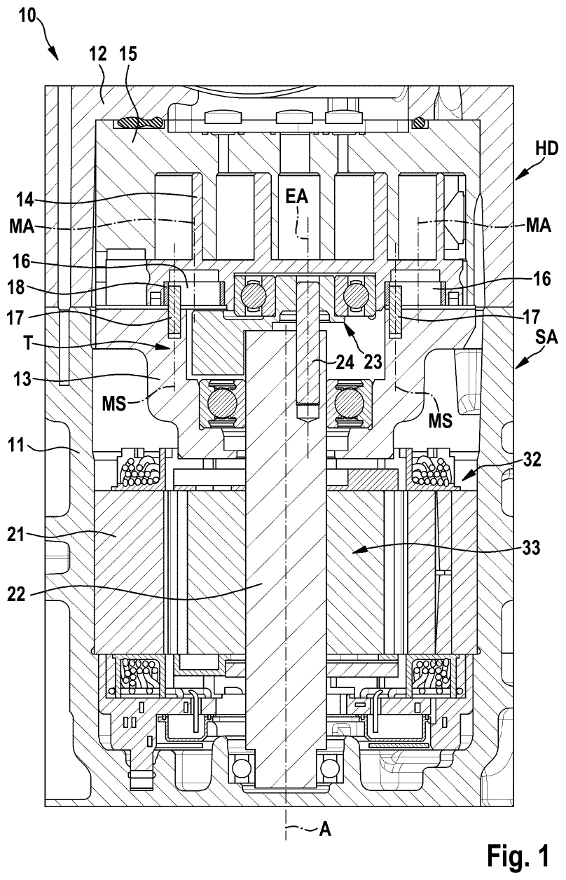

FIG. 1 shows a scroll compressor 10, which has a housing 11 with a housing cover 12 and an intermediate housing wall 13. The intermediate housing wall 13 extends over the inner diameter of the housing 10.

Arranged inside the housing 10 is an electric drive unit 21, which comprises an electric motor with a stator 32 and a rotor 33. The rotor 33 is connected to a drive shaft 22 in a rotation-proof manner. The drive shaft 22 extends through the intermediate housing wall 13 and has an axis A. The drive shaft 22 is also connected to an eccentric bearing 23 by an eccentric bolt 24. The eccentric bearing 23 comprises an axis EA, which is eccentrically arranged with regard to axis A of the drive shaft 22 and is therefore referred to as the eccentric axis EA.

The eccentric bearing 23 is fixed in a displacement spiral 14 so that the eccentric bearing 23 supports the displacement spiral 14. The displacement spiral 14 is movable and engages with a stationary counter-spiral 15.

The scroll compressor 10 generally comprises a high-pressure side HD and a suction side

SA. The displacement spiral 14 separates the suction side SA, in which the drive unit 21 is also located, from the high-pressure side HD, which essentially comprises the counter-spiral 15.

On the side of the displacement spiral 14 facing the suction side SA, a plurality of cylindrical recesses 16 are formed. As can be clearly seen in FIG. 1, a ring element 18 is embedded in each of the recesses 16. The ring element 18 essentially forms a cylindrical sliding surface for a pin 17, which engages into the recess 16. In total, a plurality of pins 17 is provided, which are connected to the intermediate housing wall 13 in a rotation-proof manner and engage into the recesses 16 in such a way that they are guided along the inner surfaces of the rings 18. This combination of pins 17 and ring elements 18 forms a guide for the displacement spiral 14, which ensures that the displacement spiral 14 performs an orbital motion due to its eccentric excitation via the eccentric bearing 23.

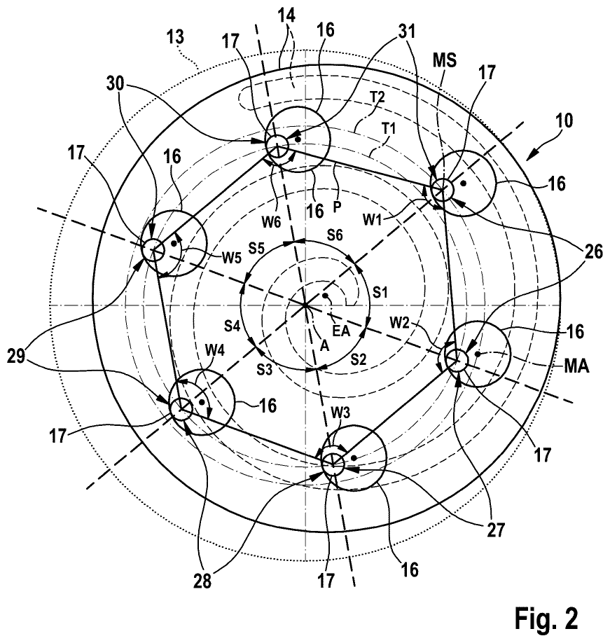

FIG. 2 shows in a cross-sectional view the arrangement of the pins 17 within the recesses 16 in the displacement spiral 14. Specifically, a cross-sectional view of the displacement spiral 14 is shown. A dotted line also indicates the intermediate housing wall 13 located behind the displacement spiral 14 in the view. It can be seen that the displacement spiral 14 slides eccentrically on the intermediate housing wall 13.

For all exemplary embodiments, the pins 17 span a virtual polygon P, which is symbolically represented in the respective illustrations. The polygon P comprises interior angles W1, W2, W3, W4, W5, W6. Two adjacent pins 17 form a pair 26 to 31, wherein each pair spans a pin pair angle S1 to S6 around the axis A of the drive shaft 22. The corners of polygon P lie on a central axis MS of pin 17.

Likewise, for all exemplary embodiments, pin 17 is arranged off-centre in the respective recess 16. Specifically, the pin 17 slides along an inner wall of a ring element 18, which is located within the recess 16. In this respect, the recess 16 has a central axis MA, which is preferably arranged parallel to, but not congruently, the central axis of pin 17 in any state of the scroll compressor.

The exemplary embodiments in accordance with FIGS. 2 to 6 differ in the specific number and arrangement of the pins 17.

Thus, in the exemplary embodiment in accordance with FIG. 2, it is provided that five of the six pins 17 are arranged on a first pitch circle T1 with a first diameter and the sixth pin 17 on a second pitch circle T2 with a second diameter. The second diameter is larger than the first diameter. The consequence of this arrangement is that the polygon P, in this case, a hexagon, is no longer regular, but has different interior angles W1 to W6.

In particular, the interior angles W1, W2 and W6 are larger than the internal angles W3, W4, W5.

The pin pair angles S1 to S6, on the other hand, can be the same. Essentially, it can therefore be provided that pin 17, which lies on the pitch circle T2, forms a line of symmetry for the remaining four pins 17 with an opposite pin 17 on the pitch circle T1. Overall, however, there is an asymmetry in that the pins 17 are not all arranged on the same pitch circle T1, T2. This type of asymmetry has the advantage according to the invention, according to which advantage vibrations and structure-borne sound transmissions are reduced during the operation of the scroll compressor.

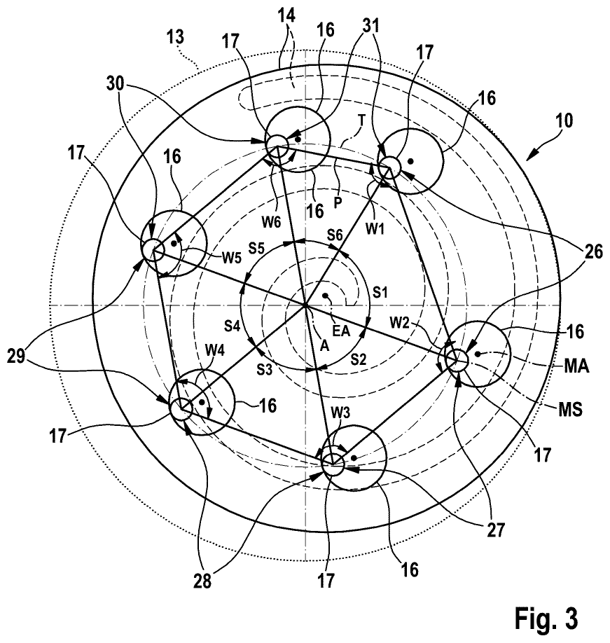

In the exemplary embodiment in accordance with FIG. 3, six pins 17 are provided as well. The pins 17 are also arranged on the same pitch circle T. Nevertheless, they span an irregular polygon P because the pin pair angles S1-S6 differ. Thus, two pins 17 form a pin pair 26, which spans a first pin pair angle S1 around the axis A of the drive shaft 22. The first pin pair angle S1 is larger than, for example, the pin pair angle S4, which is clamped by the opposite pin pair 29 around the axis A of the drive shaft 22. Such an asymmetrical arrangement of pins 17 has also shown a significant reduction in vibration and noise emissions in scroll compressors.

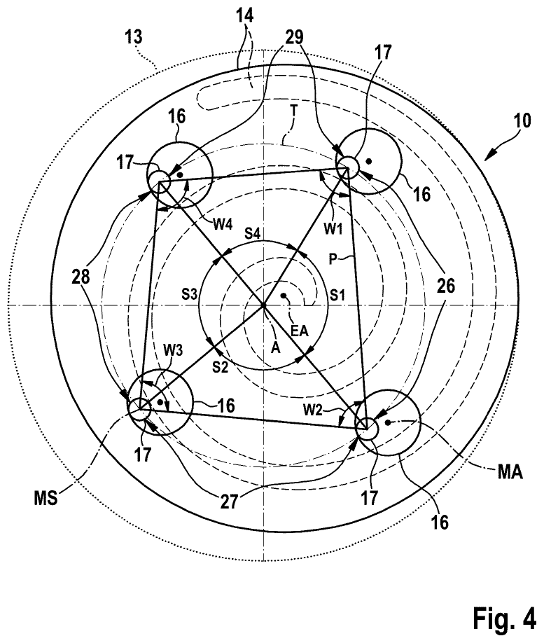

In the exemplary embodiment in accordance with FIG. 4, four pins 17 are provided, which are guided in corresponding four recesses 16. The pins 17 span a polygon P with their central axes MS, which is irregular. In particular, the polygon P forms an irregular quadrangle. It can be seen that all pins 17 are arranged on the same pitch circle T in the exemplary embodiment in accordance with FIG. 4. However, the respective pin pairs 26 to 29 have partly different pin pair angles S1 to S4. In particular, the first pin pair 26 clamps a first pin pair angle S1 with the axis A of the drive shaft 22, which is larger than the other pin pair angles S2 to S4.

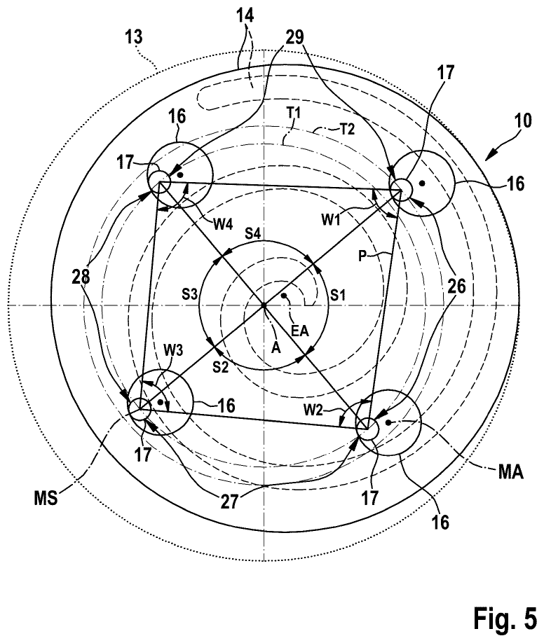

An alternative positioning of pins 17 is shown in the exemplary embodiment in accordance with FIG. 5. Here, too, four pins 17 are provided, each of which is guided in a recess 16. The pins 17 span an irregular square with their central axes MS, wherein the irregularity in the case of the exemplary embodiment in accordance with FIG. 5 results from the fact that a pin 17 is arranged on a different pitch circle T2 than the other pins 17. Specifically, three of the pins 17 are arranged on a first pitch circle T1, wherein the first pitch circle T1 extends concentrically around the axle A of the drive shaft 22 and has a first pitch circle diameter. The second pitch circle T2 has a second pitch circle diameter that is greater than the first pitch circle diameter. One of the four pins 17 is arranged on the second pitch circle T2.

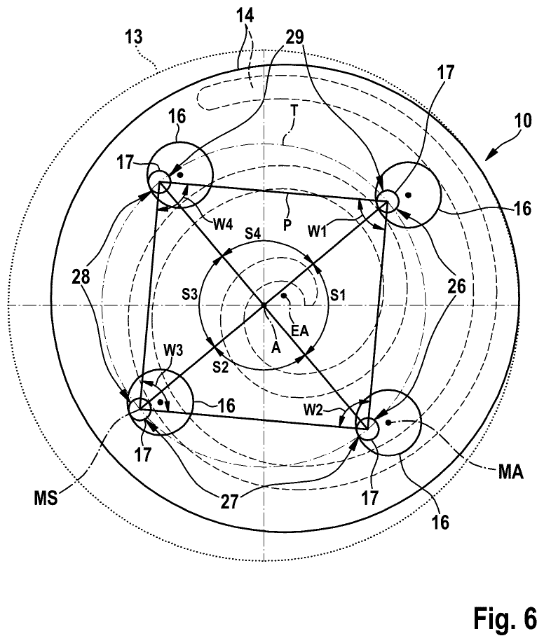

FIG. 6 shows an additional exemplary embodiment of a scroll compressor 10, wherein the scroll compressor 10 also has four pins 17, whose central axes MS span a polygon P. However, polygon P is formed as a regular polygon. Specifically, the polygon P is formed as a square. However, the decisive factor for noise minimization and vibration reduction is that the interior angle of polygon P deviates from 120°. It has been shown that even such a deviation leads to a smoother running of the scroll compressor.

### REFERENCE LIST

10 scroll compressor
11 housing
12 housing cover
13 intermediate housing wall
14 displacement spiral
15 counter-spiral
16 recess
17 pin
18 ring element
21 drive unit
22 drive shaft
23 eccentric bearing
24 eccentric bolt
26-31 pin pair
32 stator
33 rotor
HD high-pressure side
SA suction side
A axis
EA eccentric axis
MA centre axis of the recess 16
MS centre axis of the pin 17
P polygon, spanned by pins 17
S1-S6 pin pair angle
T, T1, T2 pitch circle around axis A
W1-W6 interior angle of the polygon

1. A scroll compressor, comprising a housing with a housing cover and an intermediate housing wall, an electric drive unit connected to an eccentric bearing by means of a drive shaft having an axis, a movable displacement spiral connected to the eccentric bearing in a rotatable manner around an eccentric axis, and a stationary counter-spiral engaged with the displacement spiral; wherein
the intermediate housing wall and the displacement spiral are arranged on a suction side, and the housing cover and the counter-spiral are arranged on a high-pressure side,
on the side of the displacement spiral facing the suction side, a plurality of cylindrical recesses is formed, and
on the side of the intermediate housing wall facing the high-pressure side, pins are arranged in such a way that they project into the cylindrical recesses and co-operate therewith so that a guide for the movable displacement spiral is formed, and, preferably,
in each of the cylindrical recesses, a ring element surrounding the pin is arranged,
wherein
the pins span an imaginary polygon, wherein at least one interior angle of the polygon differs from another of the interior angles and/or differs from 120°.

2. The scroll compressor according to claim 1,
wherein
three, four, five, seven, eight, nine or more pins are provided.

3. The scroll compressor according to claim 1,
wherein
the recesses and/or the pins, in particular the ring elements, are provided with and/or touch a non-metallic material, preferably plastic.

4. The scroll compressor according to claim 1,
wherein
a pair of adjacent pins spans a pin pair angle around the axis of the drive shaft, wherein the pin pair angle of one pair differs from the pin pair angle of at least one other pair, in particular being larger and/or smaller by at least 1%, 2%, 5%, 10%, 20%, 40% or 50%.

5. The scroll compressor according to claim 1,
wherein
the pins are arranged on at least two pitch circles of different diameters around the axis, wherein in particular the second pitch circle is at least 1%, 2%, 5%, 10%, 20%, 40% or 50% larger and/or smaller than the first pitch circle.

6. The scroll compressor according to claim 1,
wherein
a stator surrounding the drive shaft, in particular comprising twelve stator grooves, a rotor comprising, in particular ten, rotor-pole pairs, and preferably seven pins.

7. The scroll compressor according to claim 6,
wherein
the number of stator grooves or rotor-pole pairs can only be divided by the number of pins with a remainder.

8. A vehicle air conditioning system
comprising
a scroll compressor according to claim 1.

9. A motor vehicle
comprising
a vehicle air conditioning system according to claim 8.

10. The motor vehicle according to claim 9,
wherein the motor vehicle comprises
an at least partially electric vehicle drive.
